(19) United States
(12) Patent Application Publication
(10) Pub. No.: US 2006/0131545 A1
(43) Pub. Date: Jun. 22, 2006

(54) Method and apparatus to facilitate printing of an electrically functional component

(75) Inventors: Krishna Kalyanasundaram, Elmhurst, IL (US); Paul W. Brazis, South Elgin, IL (US); Daniel R. Gamota, Palatine, IL (US); Abhijit Roy Chowdhuri, Manassas Park, VA (US); Jie Zhang, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 11/013,872

(22) Filed: Dec. 16, 2004

(51) Int. Cl. H01B 1/12

(52) U.S. Cl. 252/500

(57) ABSTRACT

The density (and hence thickness) of a functional ink layer (41) as comprises a part of an active printed electronic component (71) is determined through interaction (13) of the functional ink with light. This information, in turn, facilitates assessment (14) of the likely corresponding electrical performance of the electronic component. When the functional ink comprises a transparent material, a dye can be added to facilitate the desired interaction and assessment.

### TECHNICAL FIELD

This invention relates generally to active printed electronic components.

### BACKGROUND

Prior art knowledge includes use of additive printing processes to facilitate the manufacture of active electronic components. For example, functional inks comprising printable semiconductor materials, dielectric materials, or electrically conductive materials can be used to print an active electronic component such as a field effect transistor. While such components are typically larger, by many orders of magnitude, than active components as are formed using vacuum deposition techniques and the like, such components nevertheless hold considerable potential for at least some applications.

In particular, the use of something at least resembling a standard additive printing process presents at least the possibility of high-speed, relatively low-cost manufacturing. Unfortunately, while available printing processes are, in fact, capable of producing thousands or even tens of thousands of printed sheets or thousands of feet of printed film in a relatively short period of time, quality control, inspection, and/or assurance processes will typically dramatically undercut such run rates. For example, using presently available techniques and practices, systematic electrical testing of printed field effect transistors can require upwards of twenty minutes or so per transistor. Such a processing rate is quite at odds with otherwise hoped-for throughput rates. Additionally, electrical testing may be very inconvenient or impractical for the printer, as few, if any such printing facilities are properly equipped or otherwise laid out to facilitate or accommodate such testing.

Furthermore, not only are existing testing methodologies quite incapable of matching conventional additive printing processes (including either sheet fed or reel-to-reel web-based processes), such existing techniques are also relatively expensive. In particular, the testing platform itself can be relatively expensive with estimates of $500,000 for automated characterization testing platforms.

### BRIEF DESCRIPTION OF THE DRAWINGS

The above needs are at least partially met through provision of the method and apparatus to facilitate printing of an electrically functional component described in the following detailed description, particularly when studied in conjunction with the drawings, wherein:

FIG. 1 comprises a flow diagram as configured in accordance with various embodiments of the invention;

FIG. 2 comprises a detail flow diagram as configured in accordance with various embodiments of the invention;

FIG. 3 comprises a top plan view as configured in accordance with various embodiments of the invention;

FIG. 4 comprises a top plan view as configured in accordance with various embodiments of the invention;

FIG. 5 comprises a top plan view as configured in accordance with various embodiments of the invention;

FIG. 6 comprises a top plan view as configured in accordance with various embodiments of the invention; and

FIG. 7 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a functional ink is used to form at least a portion of an active printed electronic component. Interaction between the functional ink and light then serves to facilitate an assessment regarding likely corresponding electrical performance of the active printed electronic component. In a preferred approach this interaction facilitates a determination regarding the density of the functional ink as forms the above-noted portion.

In some cases the functional ink is sufficiently opaque to permit such an assessment. In other cases, however, the functional ink may comprise a substantially visually transparent material. In such a case, and pursuant to a preferred approach, a dye is mixed with the functional ink to provide a non-visually transparent functional ink. The dye, then, can support the desired light interaction and subsequent assessment regarding the likely efficacy of the resultant printed active device.

So configured, automated quality testing of printed electrical components can be more readily supported using, for example, a spectrodensitometer. Such testing can be effective at a considerably reduced cost and with greatly reduced cycle time as compared to present techniques.

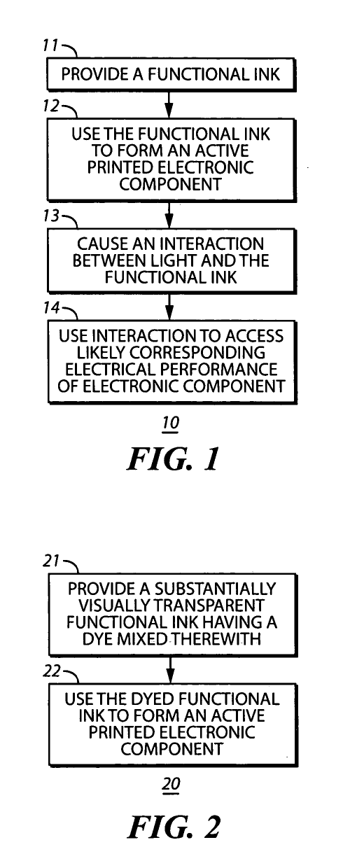

These and other benefits may become clearer upon making a thorough review and study of the following detailed description. Referring now to the drawings, and in particular to FIG. 1, one exemplary compliant process 10 provides 11 for at least one functional ink. As used herein and as will be understood by those skilled in the art, “functional ink” refers to an ink (wherein “ink” is generally understood to comprise a suspension, solution, or dispersant that is presented as a liquid or paste, or a powder (such as a toner powder).) that is electrically functional as versus merely having a graphic arts capability. Such inks, once deposited, form at least part of an active electrical component (such as, but not limited to, a bipolar transistor, a field effect transistor, a diode, or other active sensors or visual, aural, or other sensory indicators). These functional inks are further usually comprised of metallic, organic, or inorganic materials and can have variety of shapes (such as spherical, flakes, fibers, tubes, and the like), with particle sizes of a few microns to a few nanometers, or completely dissolved into solutions. Various kinds of functional ink are known in the art (including but not limited to functional inks that are electrically functional with respect to their electrically conductive nature and/or their behavior as a dielectric material or a semiconductor material) and no doubt additional such examples will be developed in the future.

This process 10 then uses 12 this functional ink to form at least a portion of an active printed electronic component. For example, as will be illustrated below in more detail, this functional ink can be used to form a part of a printed field effect transistor. (As used herein, “printed” shall be understood to refer to any of a variety of additive printing processes such as, but not limited to, lithography (including offset printing), flexography, gravure printing, and screen printing, to name a few, but does not refer, in general, to subtractive processes such as shadow masking processes that are often employed in conjunction with print resist materials and the like.) In some settings it may also be desirable to print one or more test portions using the functional ink. The potential use and benefit of such test portions will be made more clear below.

This process 10 then causes 13 an interaction between light and the functional ink (as embodied in the printed electronic component portion, one or more test portions, or both). In some cases this may comprise an interaction between a visible light frequency and the functional ink. In other cases (or in addition to visible light frequency interactions) this interaction may comprise an interaction between a non-visible light frequency (wherein the term “light” shall be understood to comprise, in general, various kinds and forms of electromagnetic energy and/or incident radiation such as but not limited to an infrared light frequency, an ultraviolet light frequency, x-ray, ultrasound, and so forth) and the functional ink. The interaction of choice can vary with the needs and/or capabilities that characterize a given application but may, for example, comprise absorbance of the light by the functional ink. More particularly, the amount of absorbance as occurs in a given example will be a function, for a given functional ink, of the density of the functional ink itself. The density, in turn, will often comprise a function of the thickness of the functional ink.

This process then uses 14 this interaction to assess likely corresponding electrical performance of the active printed electronic component. For example, a spectrodensitometer as is otherwise understood in the art can serve to determine the density of the functional ink and hence its relative thickness as noted above. This, in turn, can correlate to empirical information regarding a desired thickness range. In many cases, the thickness of a given printed layer of functional ink should preferably be within a given range. Should the functional ink be too thin, or too thick, electrical performance of the corresponding electronic component will likely be compromised in some fashion. Therefore, measured thickness of the functional ink can, at least in many instances, correlate well to expected likely performance of the corresponding printed electronic component.

In some cases, a given functional ink may be transparent, or at least sufficiently translucent, to a light frequency of interest. In such a case, the above-described process may be at least partially. For example, some functional inks serving as dielectrics are comprised of polymer materials that are substantially transparent to many light frequencies of potential value.

Referring now to FIG. 2, a useful process 20 to embellish the above-described processes provides 21 for a substantially visually transparent functional ink having a dye mixed therewith to provide a resultant dyed functional ink. This process 20 then promotes use 22 of the dyed functional ink when forming the active printed electronic component as otherwise described above.

As used herein, “dye” shall be understood to refer to a substance (such as an appropriate additive or colorant) used to convey color to another material by selectively absorbing different frequencies of light and can itself comprise a liquid or a particulate substance. In some cases the dye may itself be electrically functional but, in most cases, it may be preferable to use a substantially non-functional dye (i.e., a material that neither traps nor donates either electrons or holes). As one example, when used with a substantially transparent dielectric functional ink such as urethane acrylate polymer, a stable formulation can be achieved using a non-functional dye such as diazopaphthoquinonesulphonic ester (available from sources such as Clariant Corporation). In a preferred approach, neither the electrical characteristics nor the adhering or curing properties of the functional ink material itself are unduly changed or compromised by addition of the dye. To this end, only a relatively small amount of dye will typically be needed to achieve the desired results. For example, a mixture of the above-mentioned diazopaphthoquinonesulphonic ester with urethane acrylate polymer will provide satisfactory results using no more than about five percent of the dye as a component of the aggregate dyed functional ink.

Using such processes, an active printed electronic component can be readily fabricated using available printing techniques. In addition, the resultant component can be quickly and effectively tested for likely operability through exploitation of the optical analysis described above.

An illustrative example will now be provided through a general description of printing a field effect transistor. Those skilled in the art will quickly recognize that this example serves only as a non-exhaustive illustration and that these teachings are generally applicable to a wide variety of active printed electronic components.

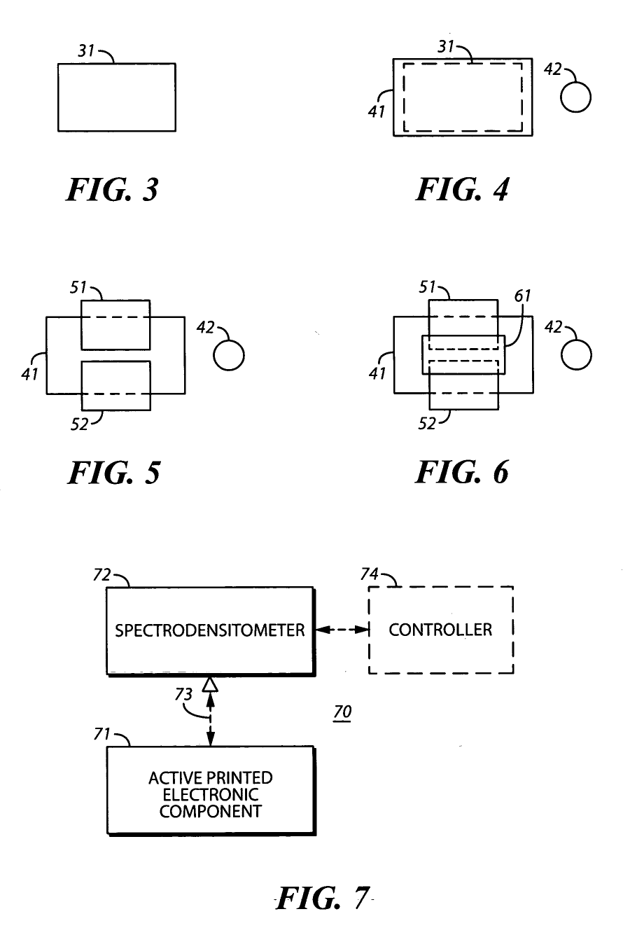

Referring to FIG. 3, a gate electrode 31 can be printed on a suitable substrate (such as a paper or plastic substrate) using, for example, an electrically conductive functional ink. Referring now to FIG. 4, a dielectric layer 41 is then printed over the gate electrode 31. In addition, in this example, a test section 42 is also printed using the same functional ink as comprises the dielectric layer 41. Being printed in a contemporaneous manner, both the dielectric layer 41 and the test section 42 should be of equivalent thickness and hence, density.

Referring now to FIG. 5, a pair of electrodes 51 and 52 (which will serve as the source and drain electrodes in the resultant active device) are then printed to overlie the dielectric layer 41. Finally, a functional ink comprising a semiconductor material is printed to provide a semiconductor layer 61 that overlies the gap between the latter two electrodes 51 and 52. (Forming an active device using printed layers of functional ink is generally understood in the art and therefore does not require further elaboration here aside from noting that test sections are not typically used when forming such devices using prior art teachings.)

So formed, and referring now to FIG. 7, the resultant active printed electronic component 71 can be tested with light 73 by, for example, a spectrodensitometer 72. For example, a Spectrophotometer system as offered by Ocean Optics can serve in this role. This testing serves to permit measurement of the density of the functional ink of interest and hence its printed thickness. Post analysis of such a thickness determination (to ascertain, for example, whether the thickness of the functional ink as corresponds to a portion of the electronic device itself, one or more test portions, or both is within an acceptable range) can be conducted by the spectrodensitometer 72 itself when the latter has sufficient processing availability and/or by an external controller 74, such as an independent computational platform.

Such a system 70 can be used, for example, to inspect, in relative real time, the high speed output of a standard printing line. This inspection will provide useful information regarding the likely electrical performance of the printed active device.

In the example provided, only a single test portion was printed and only a single functional ink layer was assessed. In a typical embodiment, of course, it may be desirable to print multiple test portions for a given functional ink layer and/or as correspond to various functional ink layers. It may also be desirable to inspect a plurality of functional ink layers using such techniques to thereby facilitate an assessment of a greater proportion of the constituent elements of the printed electronic component.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, it may be useful in some cases to examine the respective density/thickness of each functional ink layer as it is printed, whereas in other cases it may be desired to examine this parameter for all of the targeted functional ink layers as part of a post-printing review.

We claim:

1. A method comprising:
providing a substantially visually transparent functional ink having a dye mixed therewith to provide a dyed functional ink;
using the dyed functional ink to form an active printed electronic component.

2. The method of claim 1 wherein the substantially visually transparent functional ink comprises at least one of:
a dielectric material;
an electrical conductor;
a semiconductor material.

3. The method of claim 1 wherein the dye comprises a substantially non-functional dye comprising a material that neither traps nor donates either electrons or holes.

4. The method of claim 3 wherein the substantially non-functional dye comprises diazopaphthoquinonesulphonic ester.

5. The method of claim 1 wherein the dye comprises no more than about five percent of the dyed functional ink.

6. The method of claim 1 wherein the dye comprises a dye that absorbs light in a visible light spectrum.

7. The method of claim 1 wherein the dye comprises at least one of a dye that absorbs light in an ultra-violet light spectrum and a dye that absorbs light in an infrared light spectrum.

8. A functional ink comprising:
at least a first electrically functional component, which first electrically functional component is substantially visually transparent;
a dye.

9. The functional ink of claim 8 wherein the first electrically functional component comprises at least one of:
a dielectric material;
an electrically conductive material;
a semiconductor material.

10. The functional ink of claim 8 wherein the dye comprises a substantially non-functional dye comprising diazopaphthoquinonesulphonic ester.

11. The functional ink of claim 8 wherein the dye comprises no more than about five percent of the functional ink.

12. The functional ink of claim 8 wherein the dye comprises a dye that absorbs light in a visible light spectrum.

13. The functional ink of claim 8 wherein the dye comprises at least one of a dye that absorbs light in an ultra-violet light spectrum and a dye that absorbs light in an infrared light spectrum.

14. A method comprising:
providing a functional ink;
using the functional ink to form at least a portion of an active printed electronic component;
causing an interaction between light and the functional ink;
using the interaction to assess likely corresponding electrical performance of the active printed electronic component.

15. The method of claim 14 wherein the portion of the active printed electronic component comprises one of:
a dielectric material;
an electrically conductive material;
a semiconductor material.

16. The method of claim 14 wherein the functional ink comprises, at least in part, a substantially non-functional dye comprising diazopaphthoquinonesulphonic ester.

17. The method of claim 14 wherein using the functional ink to form at least a portion of an active printed electronic component further comprises using the functional ink to form at least a portion of a printed field effect transistor.

18. The method of claim 14 wherein causing an interaction between light and the functional ink further comprises causing an interaction between a visible light frequency and the functional ink.

19. The method of claim 14 wherein causing an interaction between light and the functional ink further comprises causing an interaction between a non-visible light frequency and the functional ink.

20. The method of claim 14 wherein using the interaction to assess likely corresponding electrical performance of the active printed electronic component further comprises using at least one spectrodensitometer to detect the interaction to assess likely corresponding electrical performance of the active printed electronic component.

21. The method of claim 14 wherein using the functional ink to form at least a portion of an active printed electronic component further comprises using the functional ink to form a test portion.

22. The method of claim 21 wherein causing an interaction between light and the functional ink as forms the at least a portion of the active printed electronic component further comprises causing an interaction between light and the test portion.

23. The method of claim 14 wherein using the interaction to assess likely corresponding electrical performance of the active printed electronic component further comprises using the interaction to determine a density of the functional ink as forms the at least a portion of the active printed electronic component.
